(19) United States
(12) Patent Application Publication
(10) Pub. No.: US 2002/0185024 A1
(43) Pub. Date: Dec. 12, 2002

(54) Attachment machine for making plastic base material

(76) Inventor: Ching-Shui Hsu, Taipei Hsien (TW)

Correspondence Address: BROWDY AND NEIMARK, P.L.L.C., 624 Ninth Street, N.W., Washington, DC, 20001-5303, US

(21) Appl. No.: 09/877,058

(22) Filed: Jun. 11, 2001

(51) Int. Cl. B41F 5/04; B41F 13/02

(52) U.S. Cl. 101/219

(57) ABSTRACT

An attachment machine comprises a plastic dispatching device and a cloth dispatching device for transferring at the same speed a plastic layer and a cloth layer to a winding device. In the course of the process, the cloth layer is coated by a coating device a layer of adhesive. The plastic layer and the cloth layer are then respectively heated by a first heating set and a second heating set to soften the plastic layer and to enhance the adhesiveness of the cloth layer. The plastic layer and the cloth layer are joined together by an attachment device to form a united body. The plastic layer of the united body is printed thereon the three-dimensional patterns by a cold printing device, thereby resulting in formation of a and cooled at the same time plastic base material, which is wound by the winding device for storage.

### FIELD OF THE INVENTION

The present invention relates generally to a plastic base material, and more particularly to an attachment machine for making the plastic base material.

### BACKGROUND OF THE INVENTION

The plastic base material is processed to make hand bag, inner lining of luggage, raincoat, garment, and other industrial applications. The plastic base material has a plastic layer as the surface layer having a waterproof effect, and a bottom layer which is a cloth layer attached to the underside of the plastic layer for reinforcing the strength of the plastic layer. In addition, the surface of the plastic layer is printed with a predetermined pattern, figure, or trademark to beautify the surface of the basic material. The process of making the base material involves a plastic dispatching device and a cloth dispatching device, by means of which a plastic roll and a cloth roll are respectively connected to a winding device. In the process, the cloth layer is coated with an adhesive. The plastic layer and the cloth layer are then heated by a heating set formed of a plurality of heating tubes, thereby causing the plastic layer to soften and enhancing the adhesiveness of the adhesive coated on the cloth. Thereafter, the plastic layer and the cloth layer are attached together by a rolling device in conjunction with a cooling device. Upon being rolled up by the winding device, the base material is sent to a printing machine by which the base material is printed thereon with patterns. The base material so made is defective in design in that the process is time-consuming in view of the process involving the heating, the pressing, and the printing of the base material. In addition, patterns printed on the base material do not give a three-dimensional effect.

### SUMMARY OF THE INVENTION

The primary objective of the present invention is to provide an attachment machine for making a plastic base material. The machine is efficient in heating, pressing, cooling, and printing the base material.

The present invention comprises a plastic dispatching device for winding and transferring a plastic layer; a cloth dispatching device for winding and transferring a cloth layer; a coating device for coating the cloth surface with an adhesive; a first heating set for heating the plastic layer at a predetermined temperature to soften the plastic layer so as to have a plasticity; a second heating set for heating the adhesive coated on the cloth layer so as to enhance the adhesiveness of the adhesive; an attachment device for attaching the heated plastic layer with the cloth layer so as to form an intimately-united body; a cold printing device disposed in proximity of the attachment device for printing the three-dimensional patterns on the warm plastic layer of the intimately-united body, and for cooling the intimately-united body to form a reinforced plastic base material; a winding device for winding the cooled and reinforced plastic base material.

### BRIEF DESCRIPTION OF THE DRAWINGS

FIG. 1 shows a schematic view of the device of a preferred embodiment of the present invention.

### DETAILED DESCRIPTION OF THE INVENTION

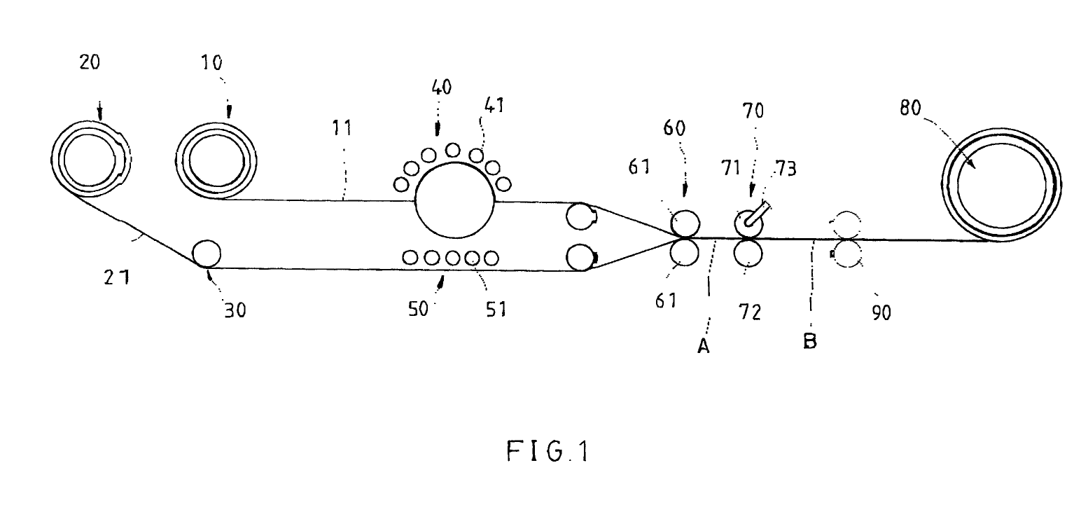

As shown in FIG. 1, an attachment machine of the present invention comprises the following devices.

A plastic dispatching device 10 is used to wind and transfer a plastic layer 11.

A cloth dispatching device 20 is used to wind and transfer a cloth layer 21.

A coating device 30 for coating uniformly a layer of adhesive of the surface of the cloth layer 21.

A first heating set 40 is formed of a plurality of heating pipes 41 on which the plastic layer 11 is heated to have a temperature of about 180 degrees to soften the plastic layer 11 to have a plasticity.

A second heating set 50 is formed of a plurality of heating pipes 51 for heating the adhesive coated on the cloth layer 21 to have a temperature of about 120 degrees so as to enhance the adhesiveness of the adhesive.

An attachment device 60 is formed of a pair of rollers 61 which are intimately joined together for forming the plastic layer 11 and the cloth layer 21 into an intimately-united body A.

A cold printing device 70 is located in proximity of the attachment device 60 and is formed of a pattern-printing wheel 71 and an auxiliary wheel 72. The pattern-printing wheel 71 is provided in the interior with a guide tube 73 through which the cooling water flows for cooling the warm plastic layer 11 and for printing at the same time the three-dimensional patterns on the plastic layer 11, thereby resulting in formation of a reinforced plastic base material B.

A winding device 80 is used to wind the reinforced plastic base material B.

A cooling device 90 is shown by the imaginary lines in the drawing and is intended to lower faster the temperature of the reinforced plastic base material B. The cooling device 90 is disposed between the cold printing device 70 and the winding device 80 and may be replaced by air cooling.

The actions and the advantages of the present invention are further described hereinafter.

As shown in FIG. 1, the plastic layer 11 and the cloth layer 21 are pulled out at the same speed by the plastic dispatching device 10 and the cloth dispatching device 20 in the direction toward the winding device 80. The cloth layer 21 is uniformly coated by the coating device 30. In the course of movement of the plastic layer 11 and the cloth layer 21, they are heated at the same position by the first heating set 40 and the second heating set 50 to facilitate the pressing process carried out by the rollers 61, so as to form the united body A. When the united body A is not completely cooled, the pattern-printing wheel 71 and the auxiliary wheel 72, which are located behind the attachment device 60, transform the united body A into the reinforced plastic base material B, which is then air dried or cooled by the cooling device 90 to facilitate the storage of the reinforced plastic base material B by the winding device 80. It is therefore readily apparent the present invention is efficient and cost-effective. In addition, the present invention is capable of making a reinforced plastic base material which is waterproof and is provided with the three-dimensional patterns. Moreover, the process of the present invention is carried out in one step.

What is claimed is:

1. An attachment machine for making a plastic base material, said machine comprising:
a plastic dispatching device for winding and transferring a plastic layer;
a cloth dispatching device for winding and transferring a cloth layer;
a coating device for coating uniformly an adhesive layer on the surface of the cloth layer;
a first heating set for heating the plastic layer to soften the plastic layer so as and to have a plasticity;
a second heating set for heating the adhesive layer on the cloth layer so as to enhance the adhesiveness of the adhesive layer;
an attachment device for joining the heated plastic layer and the heated cloth layer to form an intimately united body;
a cold printing device disposed in proximity of the rear of the attachment device to cool the warm plastic layer and to print at the same time three-dimensional patterns on the warm plastic layer of the united body, thereby resulting in formation of a plastic base material;
a winding device for winding the completely-cooled reinforced plastic base material.

2. The machine as defined in claim 1, wherein said first heating set is formed of a plurality of heating pipes for heating said plastic layer to have a temperature of about 180 degrees.

3. The machine as defined in claim 1, wherein said second heating set is formed of a plurality of heating pipes for heating said adhesive layer of said cloth layer to have a temperature of about 120 degrees.

4. The machine as defined in claim 1, wherein said attachment device is formed of a pair of rollers.

5. The machine as defined in claim 1, wherein said cold printing device has a pattern-printing wheel which is provided in the interior with a cooling water introduced thereinto.

6. The machine as defined in claim 1, wherein said cold printing device and said winding device are provided with a cooling device disposed therebetween for lowering the temperature of the reinforced plastic base material at a faster pace.
